(19) United States
(12) Patent Application Publication
(10) Pub. No.: US 2010/0302906 A1
(43) Pub. Date: Dec. 2, 2010

(54) METHOD FOR WAVEFIELD-BASED DATA PROCESSING INCLUDING UTILIZING MULTIPLES TO DETERMINE SUBSURFACE CHARACTERISTICS OF A SUBURFACE REGION

(75) Inventor: Wei Liu, San Ramon, CA (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 12/474,099

(22) Filed: May 28, 2009

(51) Int. Cl. G01V 1/00

(52) U.S. Cl. 367/59; 702/17

(57) ABSTRACT

Despite full waveform propagation capabilities offered by reverse time migration or inversion, prior art methods can generate spurious events from multiples and therefore are limited to using data without free-surface multiples. By eliminating or largely reducing artificial transmission of multiples, the enhanced reverse time migration or inversion in the present invention can correctly use data that contain free-surface and internal multiples and improve image quality or properties estimation.

### TECHNICAL FIELD

The present invention relates generally to geophysical exploration and in particular to a method of migration and inversion of seismic data using multiple reflections in such signals or data to obtain characteristics of a subsurface region of interest.

### BACKGROUND OF THE INVENTION

Reverse time migration (RTM) has been applied to imaging complex structures for oil and gas exploration and development. Compared to one-way prior art imaging methods, prior art RTM is based on solving the two-way wave equation and can propagate wavefields in all directions. RTM also preserves propagation amplitude accurately. These advantages over one-way imaging often result in significantly improved images of complex structures, especially when using wide azimuth data.

The current practice of RTM is still limited to using data with free-surface multiples removed. In this way, RTM is primarily used to focus multiple bounces (so-called prism waves) from the same hard interface such as salt flanks when compared to the one-way imaging methods. In the presence of free-surface related multiples, prior art RTM methods generate spurious events in output images due to imperfect data recording geometry (Mittet, 2002). Similarly, internal multiples can also lead to spurious events based on the same workflow.

### SUMMARY OF THE INVENTION

The present invention provides methods to mitigate the current limitations in handling multiples and can utilize data more fully in a constructive way.

One embodiment of the present invention includes a method for wavefield-based data processing including the use of free-surface and internal multiples to obtain characteristics of a subsurface region of interest. The method includes obtaining an earth model (for example, the earth model may define velocity, density, and anisotropy) and a migration model (for example, the earth model may define macro-scale migration velocity and anisotropy) related to the subsurface region of interest. The method further includes determining a modeling geometry related to the subsurface region of interest for the earth model and for the migration model, and propagating forward at least one wavefield in the earth model from at least one excitation source obtained from the modeling geometry. The method also includes propagating forward at least one wavefield in the migration model from at least one excitation source obtained from the modeling geometry. The method also includes propagating backward at least one wavefield in the earth model utilizing at least one receiver location obtained from the modeling geometry. The method additionally includes determining at least one composite wavefield from the previous forward propagated source wavefield(s) (accessed in reverse time order through either storage or re-computation) and the backward propagated receiver wavefield(s) from the earth model. The method additionally includes applying imaging conditions to the forward propagated source wavefield (but accessed in reverse time order through either storage or re-computation) from the migration model and the composite wavefield from the earth model, wherein the imaging conditions utilize the multiples present in the composite wavefield to determine characteristics of the subsurface region of interest without generating corresponding spurious events of the multiples.

It is an object of the present invention to provide a method for utilizing multiples to determine characteristics of a subsurface region of interest wherein the multiples include at least one of free-surface multiples and/or internal multiples.

It is an object of the present invention to have embodiments utilizing multiples to obtain characteristics of a subsurface region which can be used for two-way propagation methods, waveform inversion, model building or property estimation.

It is an object of the present invention to have embodiments utilizing multiples to obtain characteristics of a subsurface region of interest in the frequency or wavelet domain.

It is an object of the present invention to utilize wavefields including derivative quantities, such as, but not limited to, residual wavefields.

Another embodiment of the present invention includes a migration or inversion method which includes establishing a data set, an estimated earth model, and a migration model corresponding to an exploration volume. The method also includes setting boundary or initial conditions of wavefield propagation, and propagating wavefields from a source governed by an appropriate wave equation using the earth model. The method further includes propagating wavefields from the source again, using the migration model, and back propagating the measured traces from receivers and concurrently back propagating the earth model-based source wavefields to construct composite wavefields. The method additionally includes applying imaging conditions such as, but not limited to cross correlation to the migration model-based source wavefields and earth model-based composite wavefields to obtain subsurface images or properties.

The present invention differs from prior art methods in that the input seismic used in the present invention doesn't require preprocessing to remove or suppress multiples. If the method of the prior art takes input data without multiples removal, spurious events will be present in final images. In contrast, the present invention can constructively use multiples in the data for imaging and inversion in that artificial transmission or reflection events from multiples are eliminated or largely reduced in the wave extrapolation process to avoid spurious images. As a result, the limited surface acquisition geometry is compensated by utilizing a good estimate of the earth properties to fully utilize two-way wave propagation for various applications.

Although the above-described embodiment, by way of example, requires a good estimate of the true earth model, this condition can be relaxed to various degrees in practice and can be substituted by other approximations to result in equivalent elimination/reduction of artificial events. In addition, any imperfect elimination of spurious events is also an indication of errors in the estimated earth model which can be leveraged to improve model building. Therefore, the present invention can also be used to improve model building and properties estimation.

It should also be appreciated by one skilled in the art that the present invention is intended to be used with a system which includes, in general, an electronic configuration including at least one processor, at least one memory device for storing program code or other data, a video monitor or other display device (i.e., a liquid crystal display) and at least one input device. The processor is preferably a microprocessor or microcontroller-based platform which is capable of displaying images and processing complex mathematical algorithms. The memory device can include random access memory (RAM) for storing event or other data generated or used during a particular process associated with the present invention. The memory device can also include read only memory (ROM) for storing the program code for the controls and processes of the present invention.

As an example, one embodiment of the present invention includes a system configured to perform wavefield-based seismic data processing including utilizing multiples to obtain characteristics of a subsurface region of interest. The system includes a data storage device having computer readable data including an earth model and a migration model related to the subsurface region of interest. The system also includes a processor, configured and arranged to execute machine executable instructions stored in a processor accessible memory for performing a method. The method includes determining a modeling geometry related to the subsurface region of interest for the earth model and for the migration model, and propagating forward at least one wavefield in the earth model from at least one excitation source obtained from the modeling geometry. The method also includes propagating forward at least one wavefield in the migration model from the at least one excitation source obtained from the modeling geometry, and propagating backward at least one wavefield in the earth model utilizing at least one receiver location obtained from the modeling geometry. The method further includes determining at least one composite wavefield from the forward and the backward propagated wavefields from the earth model, and applying imaging conditions to the forward propagated wavefield accessed in reverse time order from the migration model and the composite wavefield from the earth model, wherein the imaging conditions utilize the multiples present in the composite wavefield to determine characteristics of the subsurface region of interest without generating corresponding spurious events of the multiples.

It will also be appreciated that such a system described-above may also include a display device which displays the characteristics of the subsurface region of interest. These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of the invention. As used in the specification and in the claims, the singular form of “a”, “an”, and “the” include plural references unless the context clearly dictates otherwise.

### BRIEF DESCRIPTION OF THE DRAWINGS

These and other objects, features and advantages of the present invention will become better understood with regard to the following description, pending claims and accompanying drawings where:

FIG. 1 illustrates a flowchart of one embodiment of the present invention;

FIG. 2 illustrates an embodiment of prior art RTM wherein a down-going reflection event from data traces generates spurious transmission across a reflector;

FIG. 3 illustrates an embodiment of a prior art RTM wherein the spurious transmission cross-correlates with the source wavefield and results in a spurious reflector below the true reflector;

FIGS. 4A and 4B illustrate an embodiment of the present invention wherein a simulated up-going wavefield cancels out any artificial transmission at the impedance contrast; and

FIG. 5 illustrates an embodiment of the present invention wherein enhanced RTM based on the present invention does not generate spurious images of reflectors given multiples are present in the data, whereas the conventional approach renders a spurious reflector below the true one.

FIG. 6 illustrates a flowchart of one embodiment of the present invention.

FIG. 7 schematically illustrates an example of a system for performing the present invention.

### DETAILED DESCRIPTION OF THE INVENTION

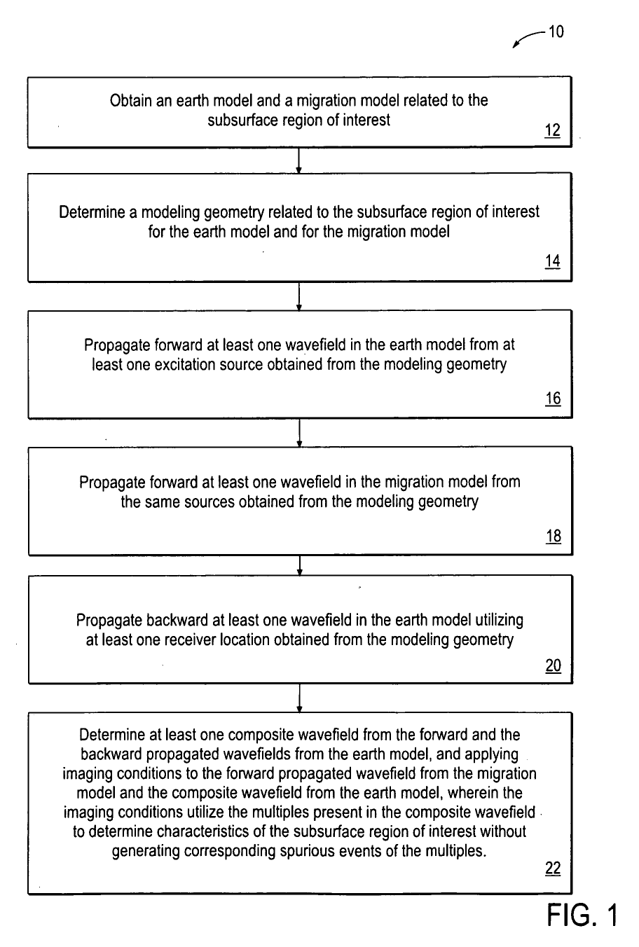

FIG. 1 illustrates a flowchart 10 of one embodiment of the present invention. That embodiment includes a method for wavefield-based data processing including utilizing multiples to obtain characteristics of a subsurface region of interest. The method includes obtaining an earth model and a migration model related to the subsurface region of interest 12. The method further includes determining a modeling geometry related to the subsurface region of interest for the earth model and for the migration model 14, and propagating forward at least one wavefield in the earth model from at least one excitation source obtained from the modeling geometry 16. The method also includes propagating forward at least one wavefield in the migration model from the same source(s) obtained from the modeling geometry 18, and propagating backward at least one wavefield in the earth model utilizing at least one receiver location obtained from the modeling geometry 20. The method additionally includes determining at least one composite wavefield from the forward (but accessed in reverse time order through either electronic storage or re-computation) and the backward propagated wavefields from the earth model, and applying imaging conditions to the forward propagated wavefield (accessed in reverse time order) from the migration model and the composite wavefield from the earth model, wherein the imaging conditions utilize the multiples present in the composite wavefield to determine characteristics of the subsurface region of interest without generating corresponding spurious events of the multiples 22.

RTM is one kind of adjoint state problem. On the one hand, the source wavefield is propagated forward over time and accessed in reverse order through either state recording or re-computation. On the other hand, seismic data are back extrapolated and correlated with the source wavefield at the times when reflections occurred. However, prior art RTM requires that free-surface multiples be removed prior to migration otherwise multiples will be focused into spurious reflections in images.

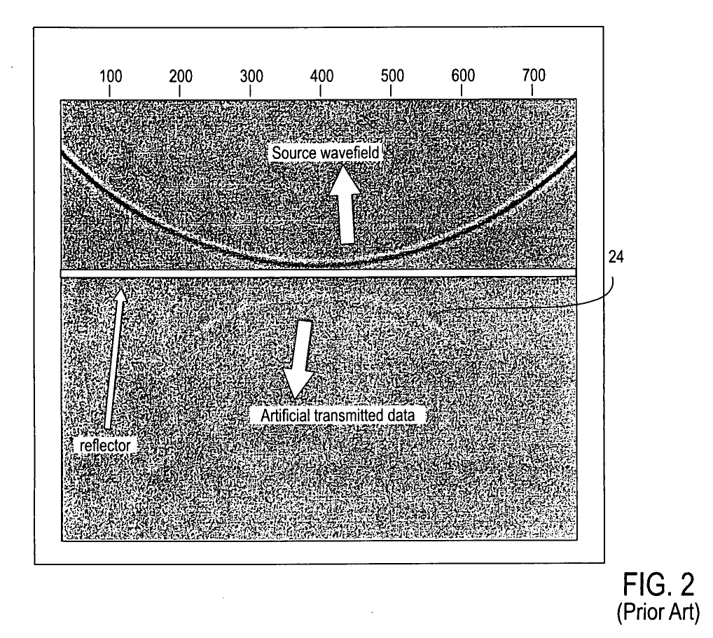

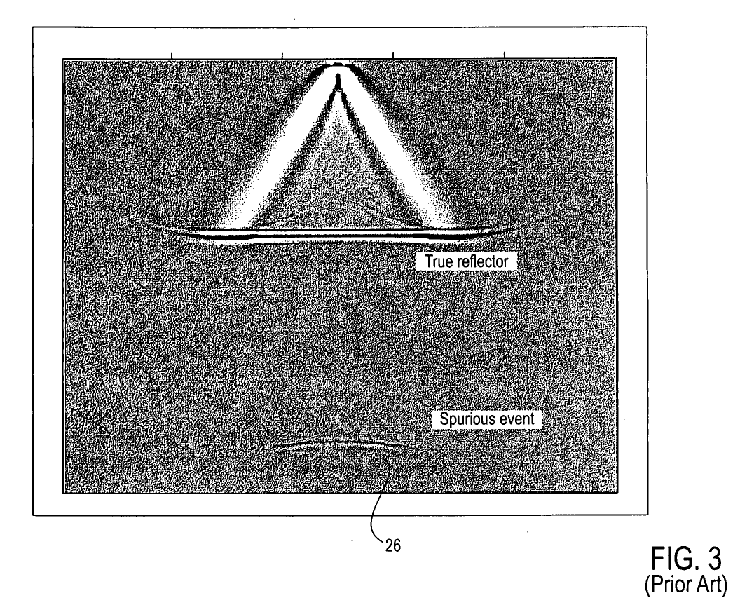

FIG. 2 illustrates that during the process of prior art RTM, back-extrapolated data from receivers can generate spurious transmission 24 across an impedance contrast. When the back-propagating wavefield is a multiple event, its spurious transmission can correlate with the source wavefield and result in a ghost image of the reflector 26 as illustrated in FIG. 3.

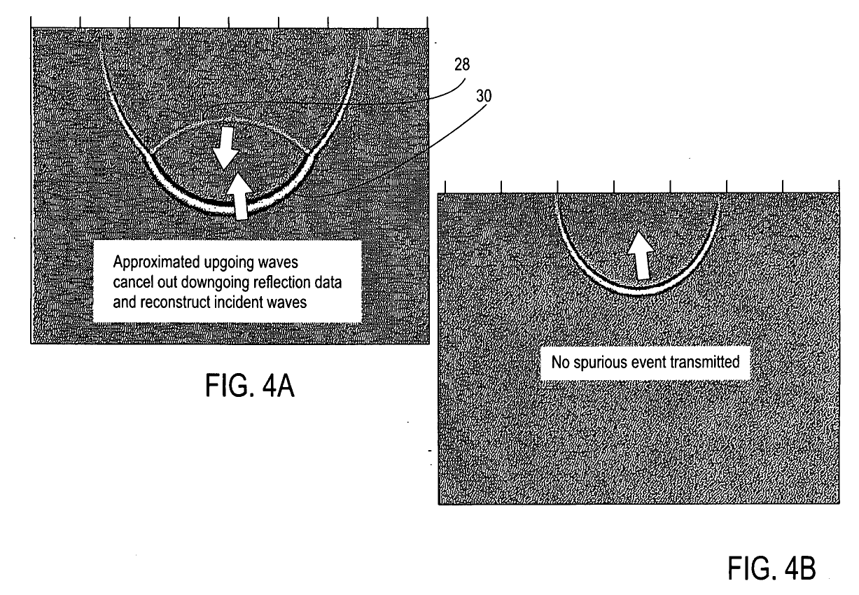

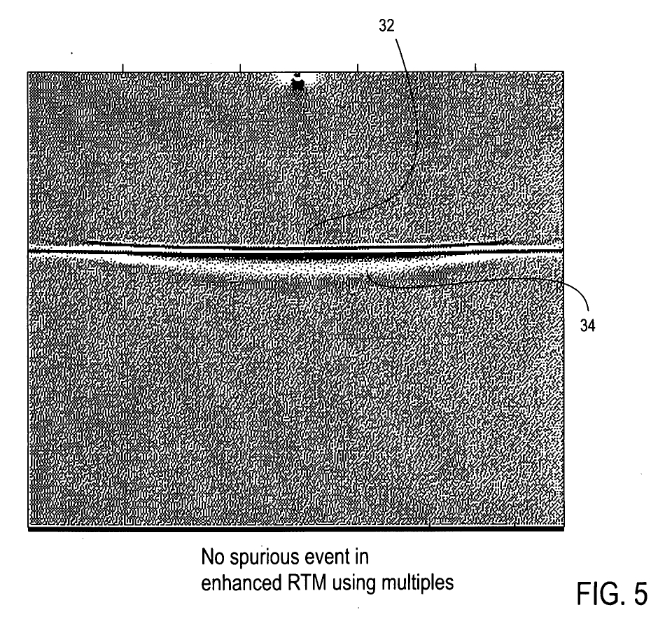

The present invention provides methods to eliminate or significantly reduce spurious transmissions/reflections which can result in ghost images. FIGS. 4A and 4B illustrate that in one embodiment of the present invention, a forward simulated wavefield is back propagated concurrently with data traces from the top surface. The two wavefields 28, 30 meet at the true reflection locations and reconstruct the incident waves. As shown, when the reconstruction of the incident waves is accurate, spurious transmission from extrapolated data traces is minimized. In this way, multiples are properly handled in two-way propagation without generating additional spurious events. FIG. 5 shows that both primary reflections 32 and free-surface multiples 34 are focused constructively at the correct locations without generating ghost images. Such artifacts reduction methods are applicable to internal multiples as well. This improved handling of propagation of multiples can be applied to any wavefield-based processing applications. For example, the multiples can be used constructively for inversion or model building. The degree of elimination of artificial transmissions can also be used to improve subsurface property estimation.

Using the methods in the present invention, free-surface multiple removal is no longer a data preprocessing requirement. Instead, free-surface and internal multiples can be used constructively towards imaging in addition to contributions from primaries. The inclusion of multiples in a constructive way can lead to improved imaging aperture, improved subsurface illumination, and improved solvability of inversion problems.

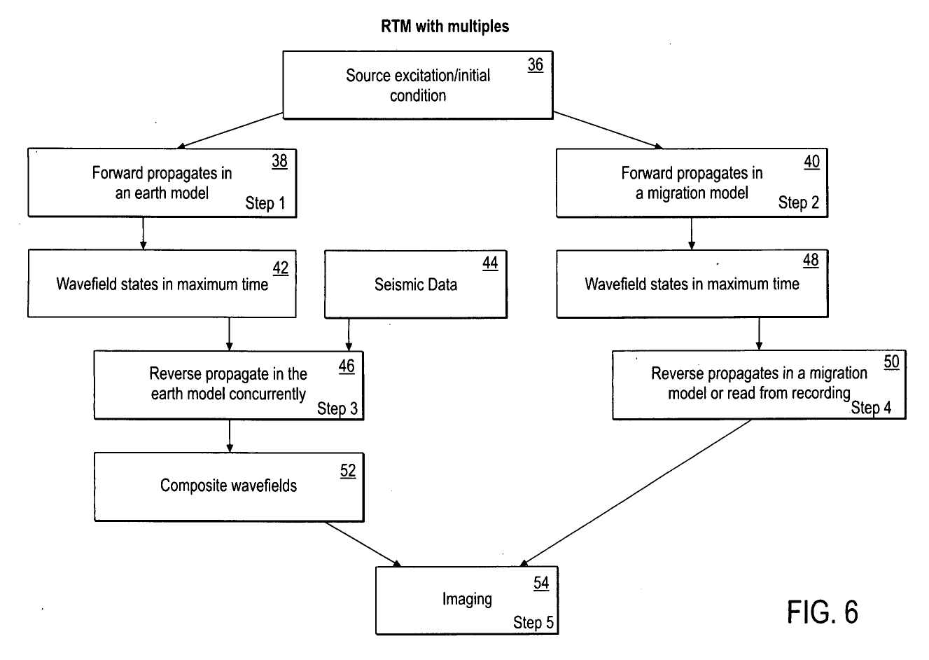

FIG. 6 illustrates another embodiment of the present invention. Using the source excitation in an initial condition 36, wavefields are forward propagated in an earth model of a subsurface region of interest 38 and in a migration model 40. Utilizing the wavefield states in maximum time 42 generated from the forward propagation in the earth model 38, the forward propagated wavefield is back propagated concurrently 46 with related seismic data 44. In addition, the wavefield states in maximum time 48 generated from the forward propagation in a migration model of the subsurface region of interest 40 are utilized in the reverse propagation in the migration model or the wavefield states can be accessed from previous electronic storage 50. Composite wavefields are determined from the forward and the backward propagated wavefields from the earth model 52. The composite wavefields from the earth model 52 and the reverse propagated wavefield from the migration model 50 can then be utilized in imaging the subsurface region of interest 54.

The above-described method is preferably implemented on either co-processor accelerated architectures, such as Field-Programmable-Gate-Arrays (FPGAs), Graphics-Processing-Units (GPUs), Cells, or general-purpose computers. The present invention provides apparatus and general-purpose computers and/or co-processors programmed with instructions to perform a method for the present invention, as well as computer-readable media encoding instructions to perform a method of the present invention.

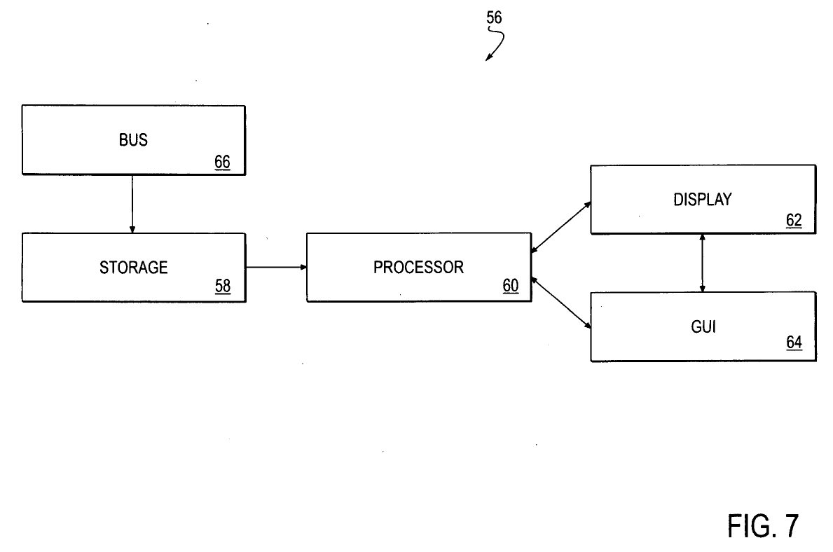

An example of a system for performing the present invention is schematically illustrated in FIG. 7. A system 56 includes a data storage device or memory 58. The stored data may be made available to a processor 60, such as a programmable general purpose computer. The processor 60 may include interface components such as a display 62 and a graphical user interface (GUI) 64. The GUI 64 may be used both to display data and processed data products and to allow the user to select among options for implementing aspects of the method. Data may be transferred to the system 56 via a bus 66 either directly from a data acquisition device, or from an intermediate storage or processing facility (not shown).

It will be clear to one skilled in the art that the above embodiments may be altered in many ways without departing from the scope of the invention. For example, as is apparent to the skilled artisan, different initial conditions or boundary conditions or a different linear combination of the PDEs in the present invention can be used in modeling and migration as convenient.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention.

What is claimed is:

1. A method for wavefield-based seismic data processing including utilizing multiples to obtain characteristics of a subsurface region of interest, the method includes:
obtaining an earth model and a migration model related to the subsurface region of interest;
determining a modeling geometry related to the subsurface region of interest for the earth model and for the migration model;
propagating forward at least one wavefield in the earth model from at least one excitation source obtained from the modeling geometry;
propagating forward at least one wavefield in the migration model from the at least one excitation source obtained from the modeling geometry;
propagating backward at least one wavefield in the earth model utilizing at least one receiver location obtained from the modeling geometry;
determining at least one composite wavefield from the forward and the backward propagated wavefields from the earth model, and applying imaging conditions to the forward propagated wavefield from the migration model and the composite wavefield from the earth model, wherein the imaging conditions utilize the multiples present in the composite wavefield to determine characteristics of the subsurface region of interest without generating corresponding spurious events of the multiples.

2. The method of claim 1 wherein the multiples include at least one selected from the group consisting of free-surface multiples and internal multiples.

3. The method of claim 1 wherein the method of utilizing multiples to obtain characteristics of a subsurface region of interest can be used for two-way wave propagation methods, waveform inversion, model building or property estimation.

4. The method of claim 1 wherein the method of utilizing multiples to obtain characteristics of a subsurface region of interest can be performed in the frequency or wavelet domain.

5. The method of claim 1 where the wavefields include derivative quantities.

6. The method of claim 5 wherein the derivative quantities include residual wavefields.

7. A system configured to perform wavefield-based seismic data processing including utilizing multiples to obtain characteristics of a subsurface region of interest, the system comprising:
a data storage device having computer readable data including an earth model and a migration model related to the subsurface region of interest;
a processor, configured and arranged to execute machine executable instructions stored in a processor accessible memory for performing a method comprising:
determining a modeling geometry related to the subsurface region of interest for the earth model and for the migration model;
propagating forward at least one wavefield in the earth model from at least one excitation source obtained from the modeling geometry;
propagating forward at least one wavefield in the migration model from the at least one excitation source obtained from the modeling geometry;
propagating backward at least one wavefield in the earth model utilizing at least one receiver location obtained from the modeling geometry;
determining at least one composite wavefield from the forward and the backward propagated wavefields from the earth model, and applying imaging conditions to the forward propagated wavefield accessed in reverse time order from the migration model and the composite wavefield from the earth model, wherein the imaging conditions utilize the multiples present in the composite wavefield to determine characteristics of the subsurface region of interest without generating corresponding spurious events of the multiples.

8. The system of claim 7 which includes a display device which displays the characteristics of the subsurface region of interest.
